(19) United States
(12) Patent Application Publication
(10) Pub. No.: US 2004/0132414 A1
(43) Pub. Date: Jul. 8, 2004

(54) Method, apparatus and system for multiple signal transmission, reception, and restoration

(76) Inventors: Andrew M. Sendyk, Calgary (CA); Ken Scott, Calgary (CA)

Correspondence Address: GOWLING LAFLEUR HENDERSON LLP, SUITE 1400, 700 2ND ST. SW, CALGARY, AB, T2P 4V5, CA

(21) Appl. No.: 10/715,045

(22) Filed: Nov. 18, 2003

Related U.S. Application Data
(60) Provisional application No. 60/429,408, filed on Nov. 29, 2002.

(51) Int. Cl. H04B 1/38

(52) U.S. Cl. 455/73; 455/562.1

(57) ABSTRACT

Techniques for increasing the capacity of a radio link, using radio signal superimposing in space and frequency and subsequent signal restoration, are described. Each of the transmitting and receiving systems are connected to a plurality of collocated antennas. The signals that are superimposed are recovered by one or a plurality of restorers. The disclosed method of signal processing involves appropriate filtering of signals, then summing them in order to restore the original individual signals and to cancel out all undesired signals received as a result of superimposing. Preferably, the spacing between antennas is optimized so that while the undesired signals are minimized or canceled out, the restored signals are maximized. In simple situations, signal filtering may be reduced to phase adjustment of the signals and the restoration may be done at RF, IF or baseband. In more complex situations, general adaptive filters implemented in baseband may be preferred. Various embodiments of the restorer are presented.

### BACKGROUND OF THE INVENTION

The present invention relates to the field of radio-communication, and especially to the transmission, reception and restoration of signals, using multiple transmitting and receiving elements.

Radio communication links are used in many applications including but not limited to telecommunication microwave trunks, wireless access for telephony, the Internet and radio relays. The dynamic development of the Internet, cellular telephony and mobile applications produces an ever increasing demand on the available resource which in these applications can be the frequency spectrum. Transmitting more information over radio links is considered as a desirable feature by many companies. The drive for increased link capacity has led to the use of high order modulation such as 128 and 256 order quadrature amplitude modulation. However, increasing the modulation order imposes difficult requirements on many link components in terms of linearity, phase noise etc. Therefore, there are practical limits to this approach.

Another approach utilizes link reuse to increase the capacity. Doubling the link capacity may be accomplished by the traditional approach of using two orthogonal (e.g. horizontal and vertical) polarizations of radio waves. The two polarizations can be made only approximately orthogonal, therefore a certain amount of “cross-talk” between signals may be present, often necessitating cross-talk cancellers. With this approach the capacity increase does not exceed a factor of two.

Antenna spatial beamforming may be used to reduce the interference between users located at different azimuth directions and to increase the overall system throughput. Since a beamformer differentiates between signal sources having different arrival angles, the beamformer is less suitable for point to point communication applications, where the signal arrives from one angle. That is, to obtain the benefits of beamforming systems, the original high speed data stream should be first demultiplexed into at least two lower speed data streams and then transmitted from more than one geographic location which creates a number of concerns. Firstly, the data stream demultiplexing, and the subsequent distribution of the lower speed data streams may be costly and complicated, requiring additional hardware and wired or wireless links. Secondly, licensing and operating the system in different spatial corridors may also increase the cost and complexity of systems based on beamforming.

A known multiple antenna system with increased data capacity is described by G. J. Foschini, in a “Layered Space-Time Architecture for Wireless Communication in a Fading Environment When using Multi-Element Antennas,” Bell Labs Tech. J., Autumn 1996, pp. 41-59. Foschini teaches that by using 8 antenna elements, the spectral capacity may be as high as 42 bit/s/Hz. The BLAST (Bell Labs Layered Space-Time) systems embody the techniques described here in U.S. Pat. No. 6,370,129 and U.S. Pat. No. 6,380,910. The BLAST system utilizes, and in fact relies, on different transfer functions between the transmitting and receiving antenna pairs. These transfer function differences are caused by the different multipath reflections. Restoring the specific signals for the BLAST system is complicated, and the reliance of the system on multipath limits the range of applications. The restoring, or equivalently “deconvolving” of the individual data signals involves estimation of channel parameters and application of some complex mathematical manipulations (such as singular value decomposition) on a matrix containing these parameters. Similar to the beamforming systems discussed above, demultiplexing and multiplexing the signal, with spatially distributed antennas, presents difficulties and additional cost in situations where a single high capacity link is needed. In addition, these techniques are not reliable when applied to “point to point” microwave systems since they will not be subject to continuous multipath reflections.

Yet another technique is described in U.S. Pat. No. 6,331,837 (the “Shattil” patent) disclosing an example of the principles of spatial interferometry multiplexing. The Shattil patent teaches a general deconvolving solution for two transmitting and two receiving antennas, and generalizes the solution for antenna arrays having more than two components. In contrast to our invention, U.S. Pat. No. 6,331,837 relies on angular differences between the transmitters, when using receiver beam forming and between the receivers, when using transmitter beamforming. This will provide the necessary differences in arrival angles and amplitude gain ratios used by Shattil. This means that either the transmitting antennas, or the receiving antennas would be geographically dispersed, raising the same concerns discussed with beamformers. Also, the patent does not teach how to deal with the multipath situation especially for multipath components arriving from the same direction as the main signal component.

Therefore, it is desirable to have an increase of data throughput, beyond that possible with polarization diversity or higher order modulation systems, for systems with transmitting and receiving antennas which are not geographically dispersed and one which is tolerant of, but does not rely on multipath reflections.

### SUMMARY OF THE INVENTION

In order to overcome the limitations inherent in the prior art related to increase of communication channel information throughput, a novel approach to communication channel reuse is disclosed.

The present invention in one of its broad aspects, discloses an approach to transmit and receive information using electromagnetic radiation wherein at least two electromagnetic radiation signals are superimposed in space and frequency, the electromagnetic radiation is detected by at least one spatially distant receiver and the signals are subsequently restored. Both the transmitting and receiving systems are each connected to a plurality of collocated transmitting or receiving antennas. As used herein the term “collocated” is defined as elements which are located in a geographically similar location, more preferably not exceeding several meters of separation and more preferably located on the same supporting structure.

A further object of the present invention is to provide a system for simultaneous transmission, reception and restoration of a plurality of individual signals superimposed in space and frequency, comprising a plurality of collocated transmitter antennas transmitting signals which reuse a common frequency band, a plurality of collocated receiver antennas receiving signals which reuse a common frequency band, a set of filters used to process the said received or transmitted signals, and at least one summing node summing the signals processed by the said filters. The filters are designed in such a way that the signals bearing the original transmitted information are restored and the interference resulting from simultaneous transmission of a plurality of signals is cancelled or at least significantly reduced.

A further object of the invention is to provide for a method for simultaneous transmission, reception and restoration of a plurality of individual signals superimposed in space and frequency, comprising transmitting and receiving a plurality of signals where the transmitting antennas are collocated and the receiving antennas are collocated and the said antennas reuse a common frequency band, applying a set of filters to the said received or transmitted signals, and summing the signals processed by the said filters restoring at least one original signal and reducing the interference resulting from the simultaneous transmission of a plurality of signals.

A further object of the invention is to provide restorer implementations for use in a system with simultaneous transmission of multiple radio signals superimposed in space and frequency, the said apparatus comprising interface means to a plurality of collocated receiver antennas processing signals which reuse a common frequency band, a set of filters, which is used to filter the said received signals, and at least one summing node which sums the signals produced by said filters restoring at least one original individual signal and reducing the interference resulting from simultaneous transmission of a plurality of signals.

Further, the invention provides for the optimization of the separation between collocated transmitting antennas and between collocated receiving antennas, relative to the distance between the transmitting and receiving antennas in the said transmitting and receiving systems so that the restoration of the received desired signal results in a reduction, more preferably cancellation of at least one interfering signal simultaneous with constructive superposition of at least one desired signal.

Further provided is a disclosure wherein each original individual information bearing signal is assigned to a single transmitting antenna and the said signal restoration is performed in the receiving system.

More specifically, the invention includes a means to perform the entire signal restoration at the carrier or an intermediate frequency. This may include a means where the filters used in the restorers may be reduced to simple phase shifters.

Alternatively, the invention includes a means to perform the signal restoration at baseband. This includes a means where the filters used in the restorers may be reduced to single tap complex multiplications which adjust the phase and amplitude of the received signals, but in general, multi-tap filters may be required.

More specifically the invention may include a means to adjust the attributes of the filters to accommodate changes in the propagation channels between transmitting and receiving antennas. The adjustments may be facilitated by addition, to at least one original information bearing signal, a training signal when other signals may be paused. In other embodiments of the invention, a pilot tone signal is added to at least one original signal. In other embodiments, a spread spectrum signal is added to the information bearing signal.

The invention may also include a means to calculate the values of the adjustments and the said means may use adaptive techniques. The disclosed means may enforce cancellation of additionally added signals, thereby canceling interferers. In other embodiments of the invention, the channel's propagation matrix is estimated, then, subsequently inverted and the inverted matrix elements are used as the attributes of the said set of filters. In other embodiments, the attributes are calculated so that the filters' responses are estimates of the responses of the propagation channels between appropriate transmitting and receiving antenna pairs.

Further, the invention includes a means wherein the signal premixing is performed in the transmitting system, containing the filters modifying the original individual signals. Here the restoration process may be accomplished directly by the physical superposition of radio waves on the individual receiving antennas, which in this case act as the summing nodes. More specifically, an implementation with feedback from the receiving system to the transmitting system is disclosed, the said feedback used to adaptively adjust attributes of the said filters.

Further provided is a disclosure of a system implementation comprising a means of restoration of signals superimposed in space and frequency and other diversity means, including but not limited to one utilizing orthogonally polarized electromagnetic radiation.

The accompanying drawings, which are incorporated in and constitute a part of this specification, illustrate preferred embodiments of the method, system and apparatus according to the invention and, together with the description, serve to explain the principle of the invention.

### BRIEF DESCRIPTION OF DRAWINGS

FIG. 1A is a diagrammatic representation of a system, where signals are transmitted by collocated antennas, superimposed, and received by collocated antennas.

FIG. 1B explains the designation of the distances between antenna transmitting/receiving pairs.

FIG. 2A is an example of the phase relationships of the system's signals when the antennas are aligned.

FIG. 2B is an example of the phase relationships of the system's signals when the antennas are not aligned.

FIG. 3 shows the block diagram of the preferred embodiment of the system containing a restorer.

FIG. 4A shows an RF or IF implementation of phase shifting used in the restorer.

FIG. 4B shows the baseband implementation of phase shifting used in the restorer.

FIG. 5 illustrates one example of the transmitted data signals and their pauses, used to facilitate restorer adjustment.

FIG. 6A shows an embodiment of the restorer which uses the matrix generation and inversion technique.

FIG. 6B shows an embodiment of the restorer which is based on cancellation of an interfering signal measured during paused transmission.

FIG. 6C shows an embodiment of the restorer which is based on propagation channel estimation and cancellation of interfering signals based on these estimates.

FIG. 7 illustrates an example of transmitted data signals, including the added pilot tones, facilitating restorer adjustment.

FIG. 8A is an embodiment of a restorer which uses transmitted pilot tones and the matrix generation and inversion technique.

FIG. 8B is an embodiment of a restorer based on detection and minimization of a pilot tone through feedback and adaptive filtering.

FIG. 9 illustrates one example of the transmitted data signals and their additive low level spread spectrum components which are used to facilitate restorer adjustment.

FIG. 10A shows an embodiment of the restorer using channel estimation facilitated through addition of spread spectrum signals to the data signals.

FIG. 10B shows an embodiment of the restorer which uses spread spectrum signals combined with the data signals and is based on detection and minimization of an additive spread spectrum signal.

FIG. 11 is a diagrammatic representation of a system, where signals are transmitted by three collocated antennas, superimposed, and received by 3 collocated antennas.

FIG. 12A is an example of the phase relationships of the system's signals using pre-mixing within the transmitter system when the antennas are aligned.

FIG. 12B is an example of the phase relationships of the system's signals using pre-mixing within the transmitter system when the antennas are not aligned.

FIG. 12C shows a block diagram of a system using pre-mixing within the transmitter system.

FIG. 13 shows a system with signal restorers combined with cross polarization interference cancellers

### DETAILED DESCRIPTION OF THE PREFERRED EMBODIMENTS

As used herein, “radio signal” means any information bearing electromagnetic (EM) radiation, propagating through space capable of being detected at some spatially distant location. As used herein, an “antenna” means an element or set of elements used to transmit or receive EM radiation. As used herein, a “pilot tone” signal means a sinusoidal signal of audible or non-audible frequency. The term “phasor” means a vector, with its amplitude and phase used to represent a signal's instantaneous amplitude and phase. The term “RF” will be used to denote radio (or carrier) frequency and the term “IF” will be used to denote an intermediate frequency. The term “baseband” will be used to denote signals which have their carrier translated to zero frequency.

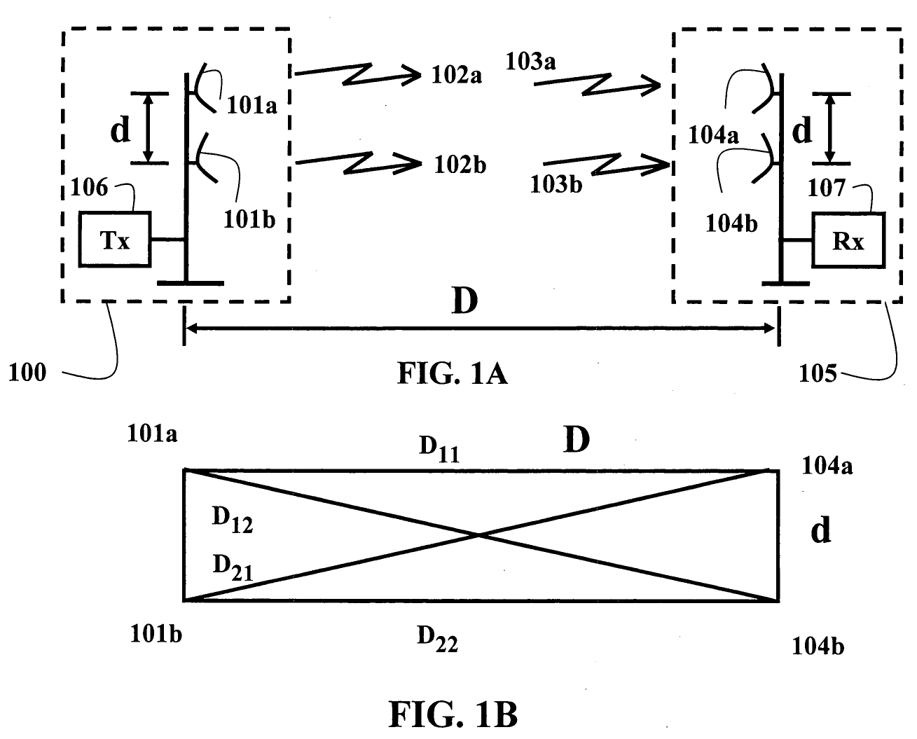

FIG. 1A illustrates a system with two transmitting and two receiving antennas where both the transmitting and receiving antennas are collocated. In the system, two signals 102a and 102b are simultaneously transmitted by antennas 101a and 101b using the same carrier frequency. The collocation of antennas allows the operator, while increasing the data rate using the techniques disclosed herein, to use a single space corridor for the radio link minimizing the chance of interference with other users and simplifying the licensing process. A transmitter system 100 contains the transmitter 106 providing radio signals 102a and 102b transmitted by antennas 101a and 101b. In addition to components which are well known to those skilled in the art, including but not limited to modulators, upconvertors and power amplifiers, the transmitter also contains components which facilitate the restorers' adjustment, as described later. The receiver 107 is part of an overall receiver system 105. On this drawing all antennas are perfectly aligned, i.e. antenna locations form a perfect rectangle. Although, for demonstration of the present invention, the system is illustrated with two antenna pairs, a plurality of antennas at each of the transmitting and receiving systems may be used. The signals 103a and 103b are received by two receiving antennas 104a and 104b. The separation between the two transmitting (and the two receiving) antennas is designated as “d” and the distance between the transmitting and receiving sites is “D”.

FIG. 1B shows the geometry of the transmitter and receiver antennas in the ideal case. D₁₁ is defined as the distance from transmitting antenna 101a to receiving antenna 104a and D₂₂ is defined as the distance from transmitting antenna 101b to receiving antenna 104b. These will be referred to, herein, as “direct paths”. D₁₂ is defined as the distance from transmitting antenna 101a to receiving antenna 104b and D₂₁ is defined as the distance from transmitting antenna 101b to receiving antenna 104a. These will be referred to, herein, as “cross paths”. In the case which is considered ideal, when the length of the cross paths exceed the direct paths by approximately ¼ of a wavelength, the transmitted signals can be optimally separated, as explained later.

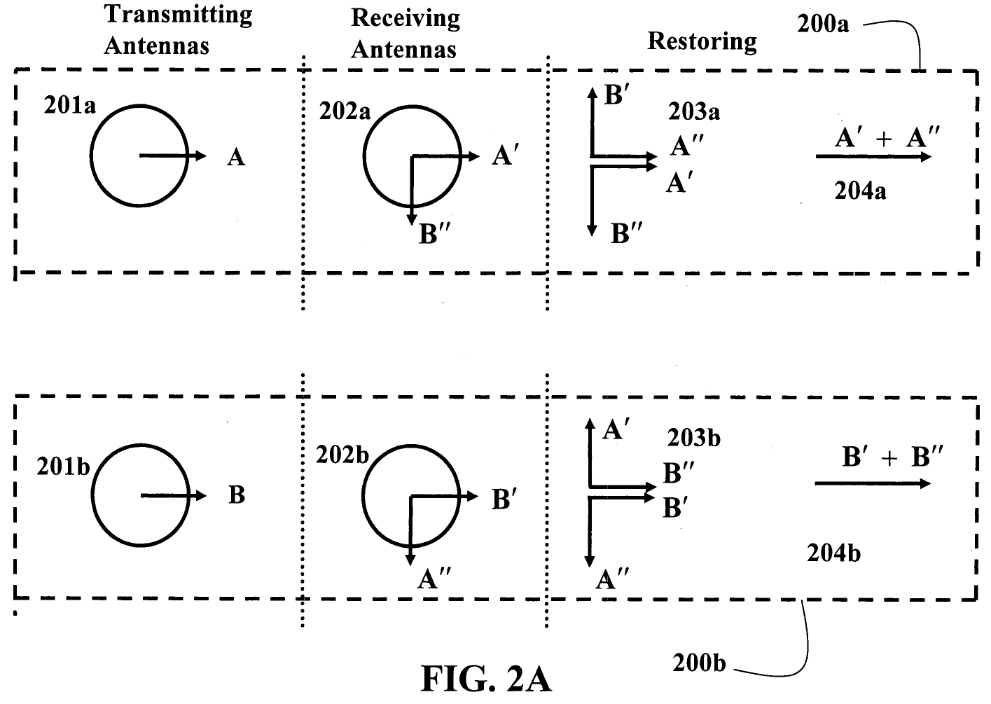

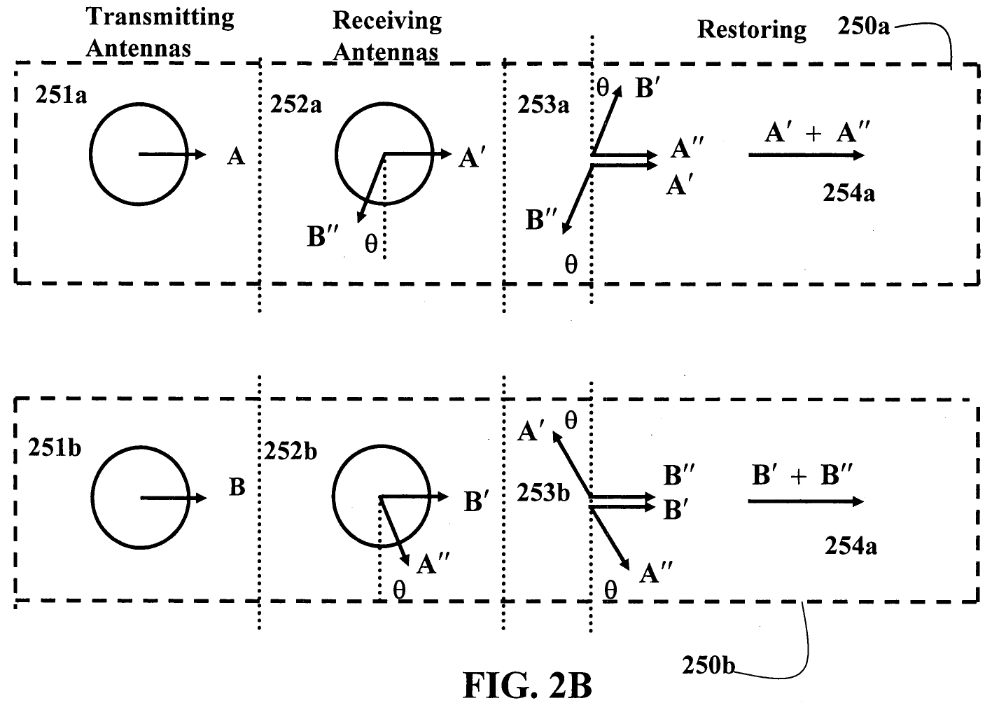

FIG. 2A shows the signals' phasor representations applicable for restoration of signals received at the receiving antennas 104a and 104b. These phasor representations are equivalents of the transmitted signals shown as 102a and 102b in FIG. 1A. It will be assumed, for illustration purposes, that the phase shift caused by the transmission in the direct paths is a multiple of 360°. This does not have to be true, in practice, since only the relative phases of the received signals need to be accounted for. The signal transmitted from 101a will be referred to as signal “A”, and the signal transmitted from 101b will be referred to as signal “B”. Signals corresponding to the first restorer are shown in 200a, where “A” is the desired signal and “B” is the interfering signal. Signals corresponding to a second restorer are shown in 200b, where “A” is the interfering signal and “B” is the desired signal. The phasors of the transmitted signals are shown in 201a and 201b. The single primed phasors “A′” and “B′” shown in 202a and 202b are the phasors of the received signals which result from transmission of signals “A” and “B”, respectively, along the direct paths. The double primed quantities “A″” and “B″” also shown in 202a and 202b are the phasors of the received signals which result from transmission of the signals “A” and “B” respectively, along the cross paths. Although individual phasors are shown, it will be understood by one skilled in the art that the phasor of the received signal is the superposition of the individual phasors. The phasors of the signals on the first antenna, 104a are shown in 202a, and for the second antenna, 104b are shown in 202b. For the restorer illustrated in 200a, the signals from the first antenna are summed with properly phase shifted versions of the signals from the second antenna. This is shown in 203a, and the final result in 204a. For the second restorer, the signals from the second antenna are summed with properly phase shifted versions of the signals from the first antenna. This is shown in 203b, and the final result in 204b. Illustration of the restoration process will be aided by considering the angles of the relevant phasors. Considering the ideal case with the first restorer only, a signal following the cross paths will experience a signal delay by quarter of a wavelength or equivalently a −90° phase shift. The signal being received by 104a will be the “A” signal, plus the “B” signal shifted in phase by −90°. Similarly, the signal being received by 104b will be the “B” signal plus the “A” signal shifted in phase by −90°. If the signal from 104a is added to the signal from 104b, shifted by an additional +90° as shown in 203a, the result is a signal “A” of twice the original strength, with none of signal “B” as shown in 204a. In summary, the coincidence of cancellation of signal “B” with the constructive superposition of the restored signal “A” is realized due to additional phase shift of 90° in the crosspath, accomplished by optimizing the separation distance d in relation to the distance between receiving and transmitting sites D.

While FIG. 2A shows signals which are obtained when the antennas are perfectly aligned, it would be much more common in practice to operate with a system undergoing some antenna motion or exhibiting some other imperfection. FIG. 2B illustrates a case where the antennas are “misaligned”, perhaps due to an antenna mast being deflected, for example, due to wind. In this case, the extra propagation delay of the signals in the cross paths cause the phase shift of the resulting signals to be different than 90°. Even in this case, the restorer may still perform very good cancellation of one signal and near optimum constructive combining of another one. The signals corresponding to the first restorer are shown in 250a. Signals corresponding to a second restorer are shown in 250b, where “A” is the interfering signal and “B” is the desired signal. These references to signals “A” and “B” and also to “A′” and “B′” and “A″” and “B″” are the same as those used in the discussion accompanying FIG. 2A. The phasors of the transmitted signals are shown as 251a and 251b. The phasors of the signals on the first receiver antenna are shown in 252a, and for the second receiver antenna are shown in 252b. For the first restorer, the signals from the first receiver antenna are summed with properly phase shifted versions of the signals from the second receiver antenna. This is shown in 253a, and the final result in 254a. For the second restorer, the signals from the second receiver antenna are summed with properly phase shifted versions of the signals from the first receiver antenna. This is shown in 253b, and the final result in 254b. In order to obtain effective signal restoration (i.e. good constructive superposition of restored signals when the undesired signal is canceled), it is required that a sum of the angles between “B″” and “A′” and between “A″” and “B′” is maintained close to ±180°. This “angle sum” depends on the separation between antennas at both ends of the link and on the distance between receiving and transmitting sites. The angle sum will be approximately preserved with a phase change of the individual carriers, an angular slant of the antennas as well as antenna vertical misalignment. This is why the proposed systems tolerate antenna movements, changes to the propagation condition, frequency shift between carriers, carrier frequency jitters and other similar impediments.

From the above discussion, it follows that the restorer optimization condition requires that, for the ideal antenna alignment, the crosspath exceeds the direct path by odd multiples of a quarter wavelength. To illustrate the importance of optimized distance between the antennas a counter-example will be used. For example, if instead of the odd multiple of a quarter wavelength distance difference, an even multiple were implemented, the cancellation of the interfering signal would coincidentally cause cancellation of the desired signal as well. While the separation distance should be taken into consideration, it is not, in fact, too critical since the gain of the restored signal when considered as a function of the separation distance, is only slowly changing, near the optimum point.

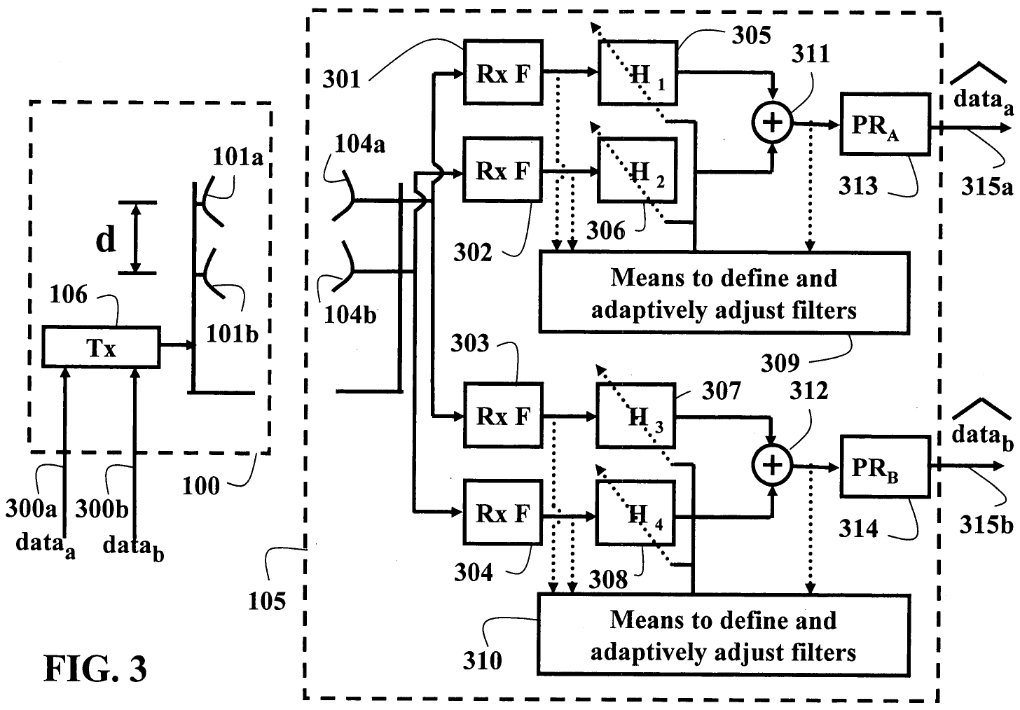

A block diagram of the preferred embodiment of the communication system, containing collocated multiple antennas, utilizing superimposed signals and containing restorers which cancel interfering signals and recover the originally transmitted signals is shown in FIG. 3. The two data sources are shown as 300a and 300b. It will be recognized by one skilled in the art, that it will be useful to include means to provide additional signals which can be used by the receiver to facilitate calculation of the estimates 315a and 315b of the two original data signals 300a and 300b. Therefore among other possibilities, the transmitted signal may include pauses, pilot tone signals or spread spectrum signals. Possible implementations of these will be discussed in the following paragraphs. The transmitter 106 may include means to generate these additional signal components. The described receiving system 105 will have the means to suitably receive, frequency shift and filter the signals. These means are well known to one skilled in the art and are represented by 301, 302, 303 and 304. These are followed by restorers shown collectively in 305, 306, 307, 308, 309, 310, 311 and 312. The signals may then undergo additional processing which is also familiar to one skilled in the art by blocks 313 and 314; said processing may include but is not limited to demodulation, equalization, error correction, etc. As part of the first restorer, the adaptive adjustment block 309 is fed by the outputs of blocks 301 and 302 or from the output of the summing node 311. Only one of these should be needed but both are shown in the diagram. Similarly, for the second restorer, the adaptive adjustment block 310 is fed by the outputs of blocks 303 and 304 or from the output of the summing node 312. Only one of these should be needed but both are shown in the diagram. The functioning of the adaptive adjustment blocks 309 and 310 will be detailed later. To illustrate the general preferred embodiment of the receiver system, it will suffice that, for the first restorer, the adaptive adjustment block will be used to determine the attributes and performance of filters 305 and 306. The filters, in turn, will modify the signals received by the receiving antennas 104a and 104b, so that at the output of the summing node 311, being the final output of the first restorer, the first restorer's interfering signal will be eliminated and the desired signal will be detected, preferably enhanced. Similarly at the final output of the second restorer, shown collectively as components 307, 308, 310 and 312, the second restorer's interfering signal will be eliminated and its desired signal will be detected, preferably enhanced. The detailed functions of the blocks presented in this diagram will be fully discussed in the subsequent descriptions.

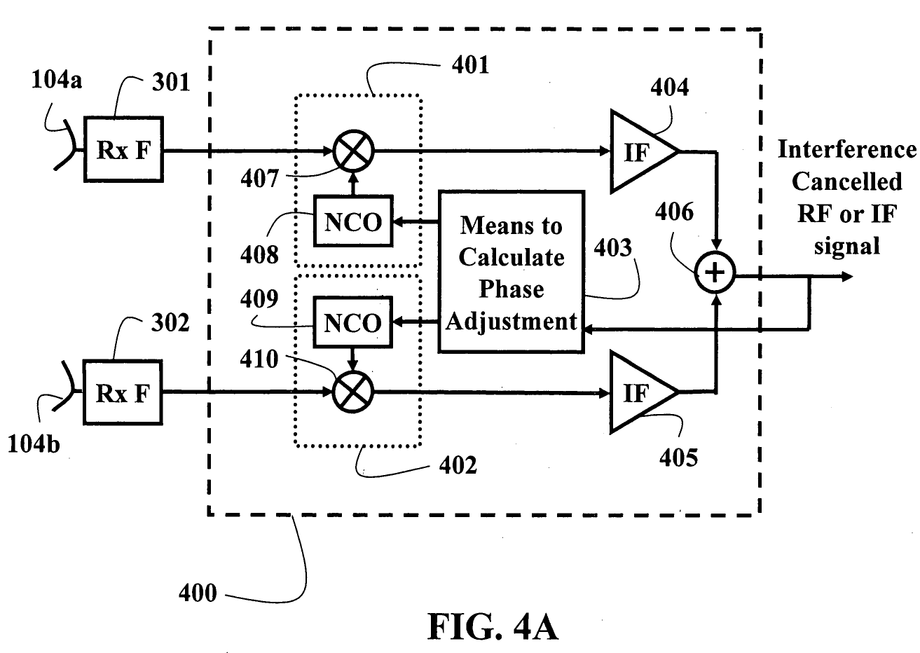

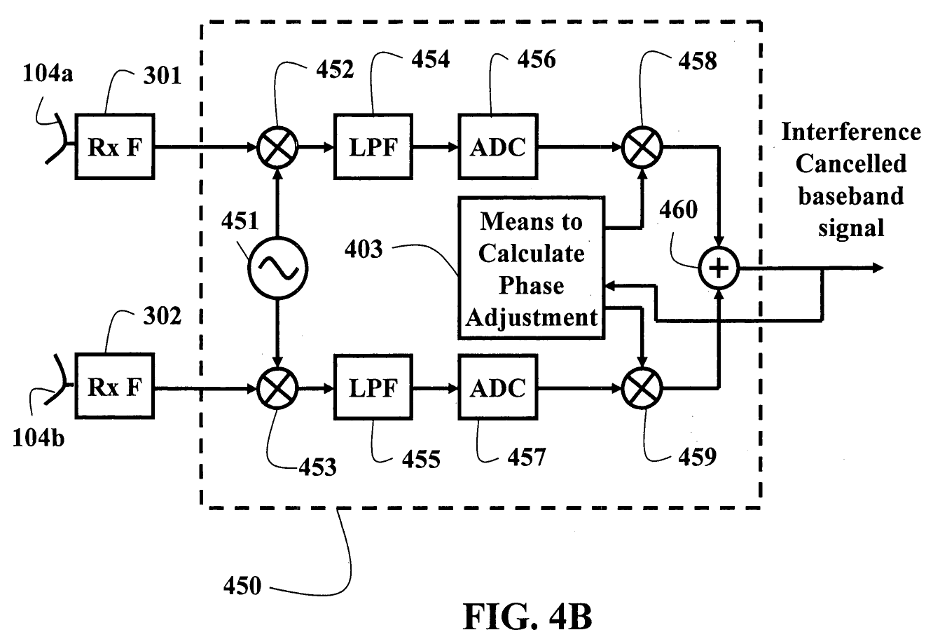

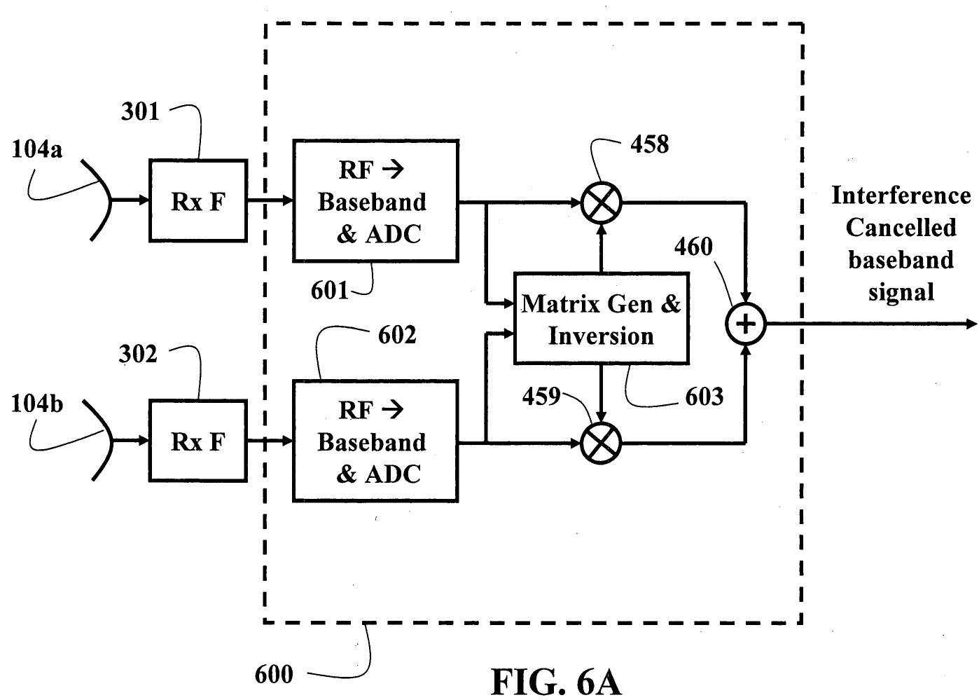

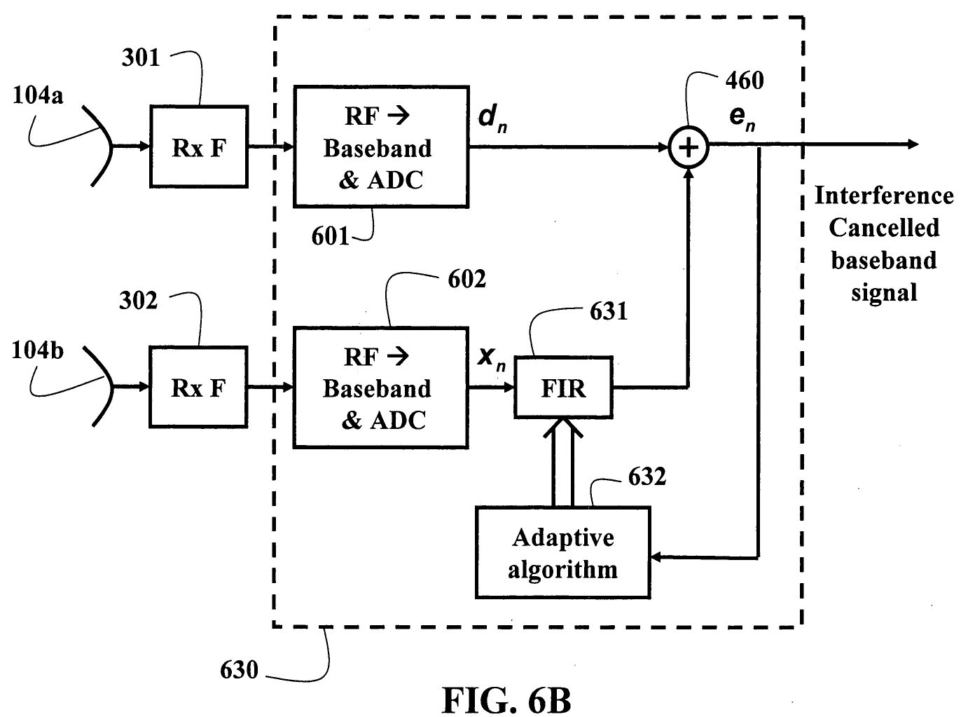

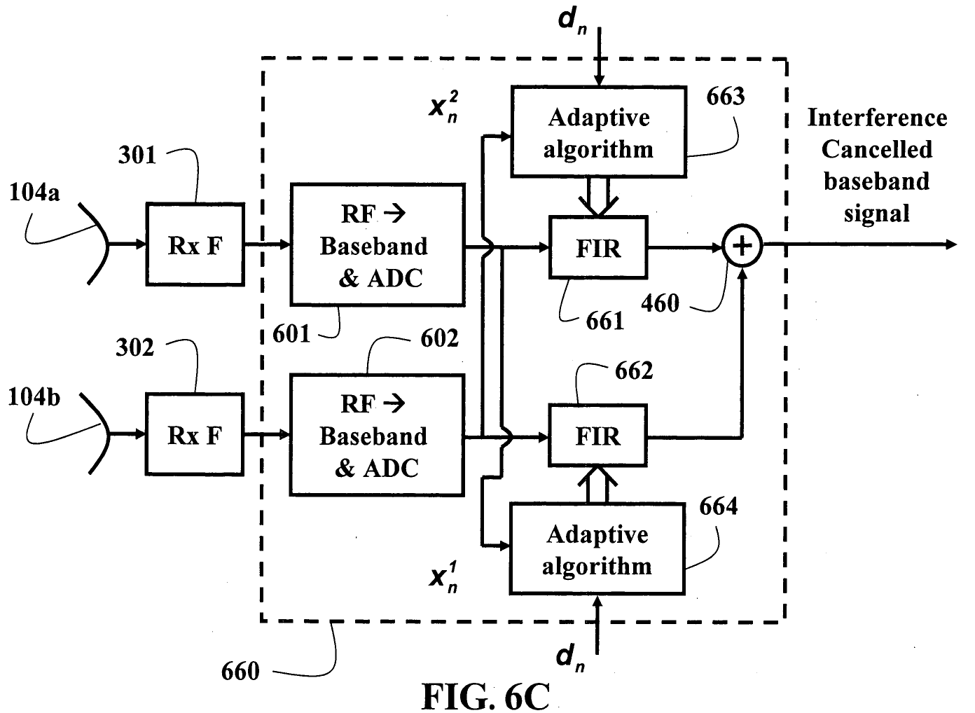

FIGS. 4 to 10, for illustrative simplicity, will show only one of the restorers. The accompanying descriptions may easily be extended to apply to the other restorer(s). These figures represent more detailed implementations of the general embodiment shown in FIG. 3. The suitability of a particular implementation will depend on many considerations including, but not limited to propagation channel delay spread, the channel dynamics, overall system requirements and system architecture. The implementation shown in FIG. 6C will be preferred in a multitude of situations, as it is capable of performing well with propagation channels having significant delay spreads, yet it is computationally simple and effective. However, the simpler cases will be described first.

In the most basic scenario, without effects caused by multipath propagation causing propagation channel delay spread, and with all signals matched in amplitude, signal restoration may be accomplished by summing phase shifted received signals. That is, the restorers can be simply implemented with signal phase shifters (complex number rotations at baseband frequencies) and a signal summing node. The required rotation of signal phasors (phase shift) may be implemented either in RF (or IF), as shown in FIG. 4A or in baseband, as shown in FIG. 4B. The discussion of both will follow.

In FIG. 4A, 400 represents the restorer, which comprises phase shifters, implemented by 401 and 402, and a means 403 to calculate the desired phase shift by analyzing the signals provided to or obtained from summing node 406, as described later. In some situations, such as for a static propagation channel with known geometry, the desired phase shift may be pre-calculated. This is followed by IF signal processing shown in 404 and 405, which will be familiar to one skilled in the art, and finally by processing through summing node 406, to produce the interference cancelled signal. The phase shift of the first signal, effected by 401, is accomplished by a numerically controlled oscillator 408 and a mixer 407. Similarly, the phase shift of the second signal, effected by 402, is accomplished by a numerically controlled oscillator 409 and a mixer 410.

In FIG. 4B, 450 represents a single restorer, which comprises phase shifters, implemented by 458 and 459, and a means 403 to calculate the desired phase shift by analyzing the signals provided to or obtained from the summing node 406, as described later. In some situations such as for static propagation channels with known geometry, the desired phase shift may be pre-calculated. This is followed by a signal summing node 460, to produce the interference cancelled baseband signal. Blocks 451, 452, 453, 454, 455, represent the receiver functions of (quadrature) demodulation which are well known to one skilled in the art. Blocks 456 and 457 represent analog to digital converters for both inphase and quadrature signals. Blocks 458 and 459 represent complex multipliers, which shift the signal's phases. Finally, the summing node 460 operates on complex numbers and produces the interference cancelled baseband signal.

In slightly more complicated situations, when matching of signal amplitudes can not be assured, but channels may still be represented by a single ray, it will be recognized that a gain adjustment will be required in at least one arm of the restorer. Signal filtering may be implemented either in RF or in baseband.

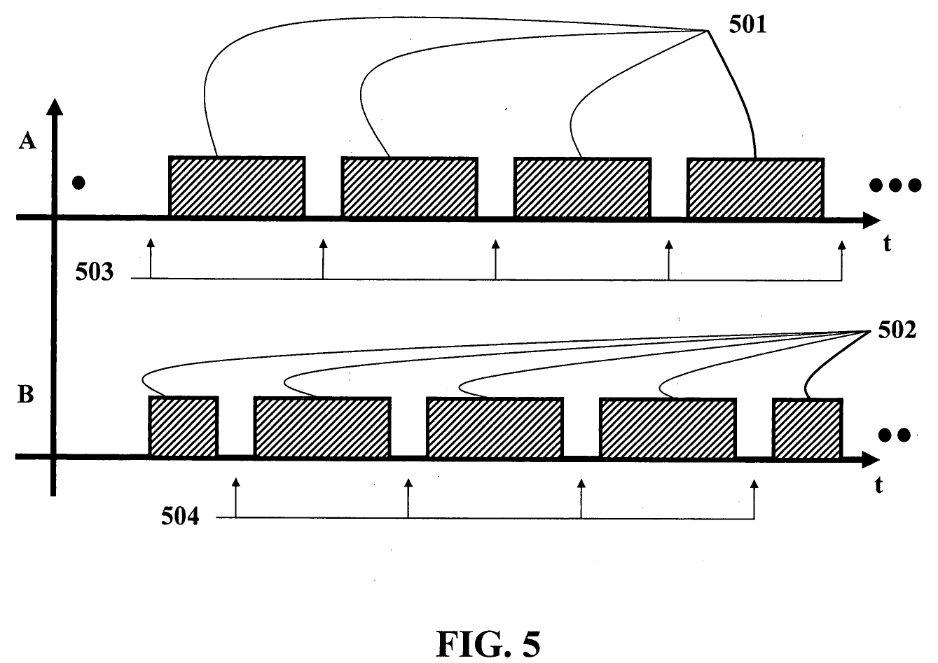

FIGS. 5 to 10 disclose implementations specifically adapted to perform well with propagation channels which are time varying.

FIG. 5 shows the alternating pausing of the two transmitted signals. The purpose of the pauses is to transmit single signals, a condition which will simplify the adjustment of the restorers' parameters. The data signals are represented by 501 and 502. The selection of the length of the pauses, shown collectively as 503 and 504, is a compromise between the acceptance of additional overhead and the provision of signals which will allow for correct operation of the receiver. In a dynamic environment, the pauses should be frequent enough that the receiver can track the propagation channel changes. They should also be of long enough duration that the propagation channels are estimated with adequate accuracy. The use of these pauses is discussed in the descriptions accompanying FIGS. 6A, 6B and 6C.

An implementation of a receiver used to obtain one of the restored signals, is shown in FIG. 6A. This implementation is especially useful when expected propagation channels exhibit only small amounts of time dispersion. For larger amounts, the structures shown in FIG. 6B and FIG. 6C are preferred. For this receiver, shown as 600, signals received by antennas 104a and 104b are amplified and filtered by 301 and 302 according to methods known by one skilled in the art, and then filtered, frequency translated, and analog to digital converted by 601 and 602. The internal configuration of 601 and 602 is variable, but also familiar to one skilled in the art. The functions of 600 which are specific to this implementation of the restorer, comprise matrix generation and inversion performed by 603, phase corrections performed by 458 and 459, and summing performed by 460. The matrix generated is a 2×2 matrix of complex numbers, each representing the phase (and magnitude) of the propagation channel between one of the transmitter antennas and one of the receiver antennas. The matrix M, contains the following elements

$$M = [ \begin{matrix}{C}_{11} & {C}_{12} \\ {C}_{21} & {C}_{22}\end{matrix} ]$$

where, in the case of only small amounts of time dispersion, C₁₁, C₁₂, C₂₁, and C₂₂ are each complex numbers where Cᵢⱼ is the baseband representation of the propagation channel from transmitter antenna “j” to receiver antenna “i”.

The coefficients of this matrix may be estimated by several techniques, but in one embodiment, are estimated during the signal pauses in two steps. When the first input signal is paused, during the periods shown as 503 in FIG. 5, the elements in the second column of the matrix M are estimated by single tap adaptive filters. When the second input signal is paused, during the periods shown as 504 in FIG. 5, the elements in the first column of the matrix M are estimated by single tap adaptive filters. These adaptive filters are well known in the art, but are also described, for the more general case of multi-tap filters, in the discussion accompanying FIG. 6B and FIG. 6C. When elements of the matrix M have been estimated, it remains to invert the matrix, and apply the numbers within this inverse through the multiplications represented by 458 and 459, and the summation represented by 460. Recall that only one of the two restorers is shown in FIG. 6A, and that the other two multiplications by the remaining elements of M⁻¹ will be accomplished in the other restorer.

FIG. 6B shows another implementation of the parts of the receiver which are specific to one of the restorers. For this receiver 630, both signals received by antennas 104a and 104b are processed by 301 and 302 according to methods well known by one skilled in the art, and then filtered, frequency translated, and analog to digital converted by 601 and 602. The internal configuration of 601 and 602 is variable, but familiar to one skilled in the art. The functions of 630 which are specific to this implementation of the restorer comprise the adaptive algorithm, implemented within 632, the FIR (finite impulse response) filter 631 being controlled by the adaptive algorithm, and the summing node 460. The adaptive algorithm 632 is activated during the pauses of the appropriate transmitted signal. During the period when all of the transmitted signals are paused, except for the interfering signal, which is to be cancelled, the adaptive algorithm 632 for the first restorer is activated. This allows the restorer to adapt in such a way as to cancel the interfering (in this case, the second) signal. The adaptation would proceed according to algorithms which are familiar to those skilled in the art, such as the “LMS” (least mean square) or “RLS” (recursive least square) adaptive algorithms. The LMS algorithm, as it applies here, is included. The samples which are input to the FIR filter 631 are referred to as xₙ. The samples which are output from 601 are referred to as dₙ, and the output of the summing node 460 is referred to as eₙ. The following definitions are used to describe the algorithm. The sampling frequency would most likely be twice the symbol frequency, but could be some other multiple, as would be recognized by someone skilled in the art.

xₙ=input to the FIR filter 631,

dₙ=output from the first RF→baseband/ADC converter 601,

eₙ=output from the summing node 460,

Wₙ=the vectorof coefficients of the FIR filter shown as 631,

Xₙ=the vector of input samples of the FIR filter shown as 631,

The superscript ^{“H”} used on a vector represents the commonly known vector operation of complex conjugate transposition. The output from the summing node 460 is calculated as

eₙ=dₙ−Wₙ^{H}Xₙ

And the filter coefficients 631 are updated according to the commonly known LMS algorithm

Wₙ₊₁=Wₙ+μeₙ*Xₙ.

FIG. 6C shows another implementation of the part of the receiver which may be used to obtain one of the restored signals. For this receiver shown as 660, signals received by antennas 104a and 104b are processed by 301 and 302 according to methods well known by one skilled in the art, and then filtered, frequency translated, and analog to digital converted by 601 and 602. The internal configuration of 601 and 602 is variable, but familiar to one skilled in the art. The functions of 660 which are specific to this implementation of the restorer, comprise the adaptive algorithms, implemented by means represented by 663 and 664, the FIR filters 661 and 662 being controlled by the adaptive algorithms 663 and 664, and the summing node 460.

During the period when all of the transmitted signals are paused, except for the interfering signal, which is to be cancelled, the adaptive algorithms 663 and 664 operating in the first restorer are activated. This allows the canceller to adapt in such a way as to cancel the interfering (in this case, the second) signal. For illustrative purposes, these adaptive algorithms will take the form of channel estimators and are detailed in the following set of equations. Let the following samples be defined:

xₙ¹=output sample from 601,

xₙ²=output sample from 602,

dₙ=transmitted known signal samples (e.g. training pattern for second channel),

Xₙ¹=set of input samples to FIR filter 661,

Xₙ²=set of input samples to FIR filter 662,

Wₙ¹=set of filter coefficients of FIR filter 661 and

Wₙ²=set of filter coefficients of FIR filter 662.

The prediction errors for the adaptive algorithms may be calculated as

eₙ¹=dₙ−(Wₙ¹)^{H} Xₙ¹,

and

eₙ²=dₙ−(Wₙ²)^{H} Xₙ².

And the coefficients of the adaptive filters are updated according to

Wₙ₊₁¹=Wₙ¹+μ(eₙ¹)*Xₙ¹

and

Wₙ₊₁²=Wₙ²+μ(eₙ²)*Xₙ².

At the end of the adaptation, the coefficients of the FIR filters 661 and 662 are fixed for a period of time, until another adaptation is required.

The following explanation of the cancellation occurring within the restorer serves to illustrate the functions of the above equations. Considering only the signal transmitted by the second transmitting antenna 101b, recalling that the first signal has been paused (and is therefore zero), the signals at the output of 601 and 602 have been subject to the propagation channels C₁₂ and C₂₂ respectively. Assuming that these propagation channels are accurately estimated, then the pair of received signals can be further filtered by C₂₂ and −C₁₂, respectively, resulting in similar signals which are then ideally cancelled by summing node 460. This has, in effect, cancelled the second signal, leaving only the (filtered) first signal when the first signal is resumed. This is also illustrated by the following equation where the input signal to the second channel is referred to as sₙ², C₁₂ is the propagation channel from transmitter antenna 101b to receiver antenna 104a, C₂₂ is the propagation channel from transmitter antenna 101b to receiver antenna 104b, and “\hat{ }” denotes estimated quantities.

yₙ=C₁₂*Ĉ₂₂*sₙ²−C₂₂*Ĉ₁₂*sₙ²

≈0.

This method of cancellation has two main advantages over methods which involve matrix inversion or channel transfer function inversion. Firstly, it tends to be numerically stable. Secondly, the FIR filters 661 and 662, even with very few coefficients, form good approximations of the impulse response of the propagation channels, leading to effective cancellation. Since only a few coefficients are required, high numerical efficiency of this implementation may be achieved.

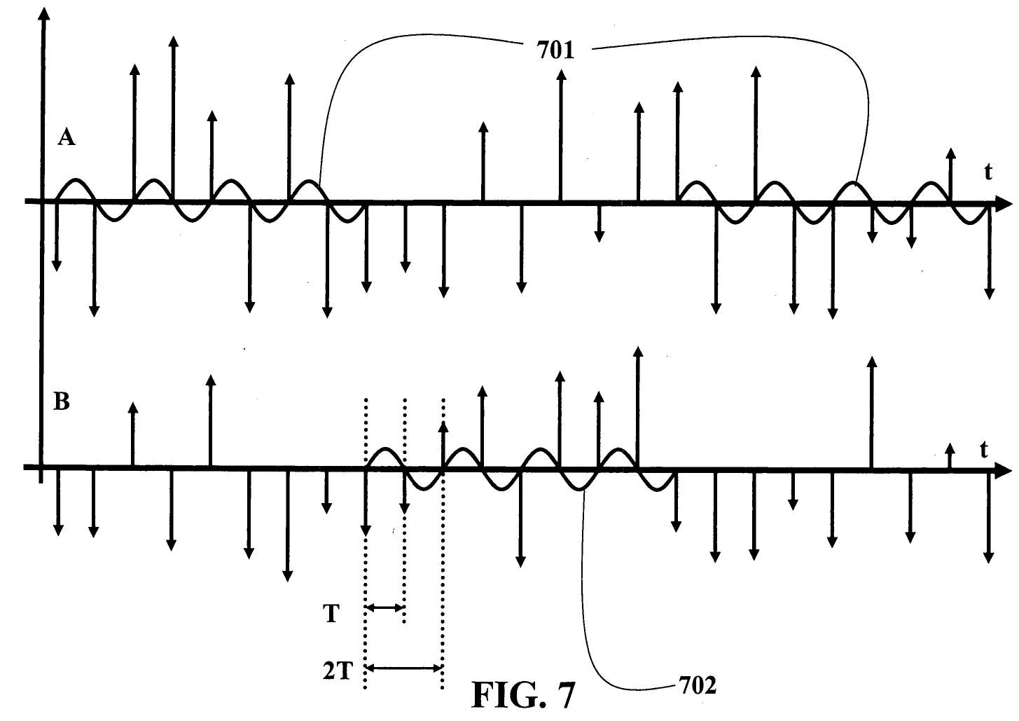

FIG. 7 shows a pilot tone signal and its relationship to the data signals. In the present invention, the purpose of the pilot tone signal is to provide the receiver with a reference which can be used to estimate the required filters attributes. The arrows separated by the symbol duration T are a representation of samples of the transmitted signals “A” and “B”, and the low level pilot tone signal is shown as a sinusoid of period 2 T, with a phase chosen so that the zero crossings of the sinusoid coincide with the data instants. The pilot tone signal is alternately added to the first signal, shown as 701, and then the second signal shown as 702.

The main advantage of systems utilizing pilot signals is that interrupted transmission of the data signals is avoided. This allows for maximizing the data throughput in the link.

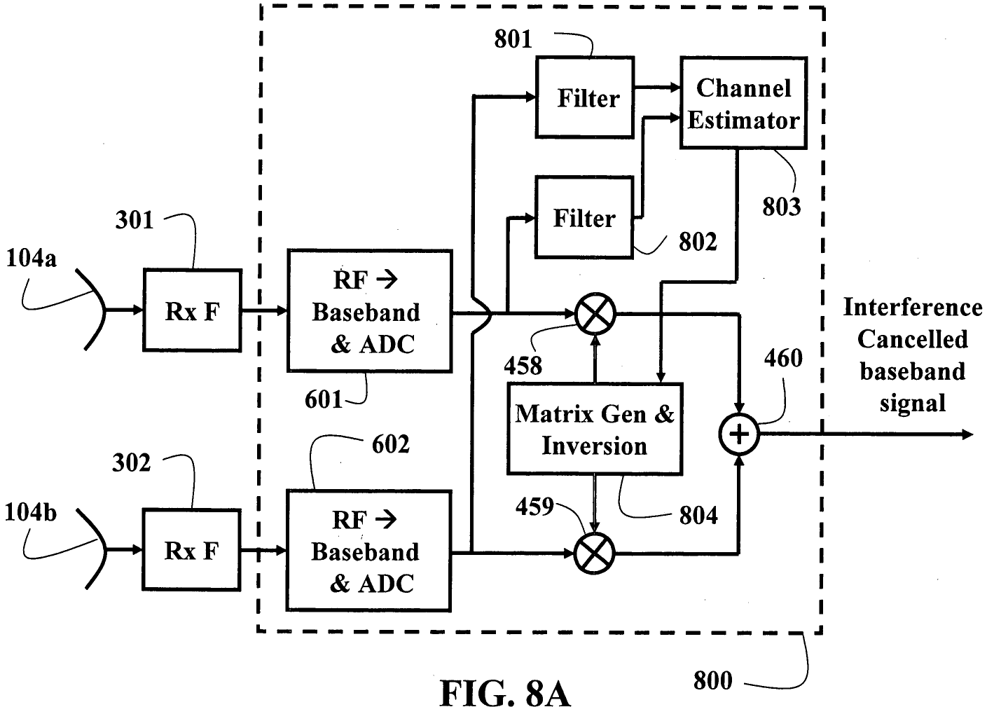

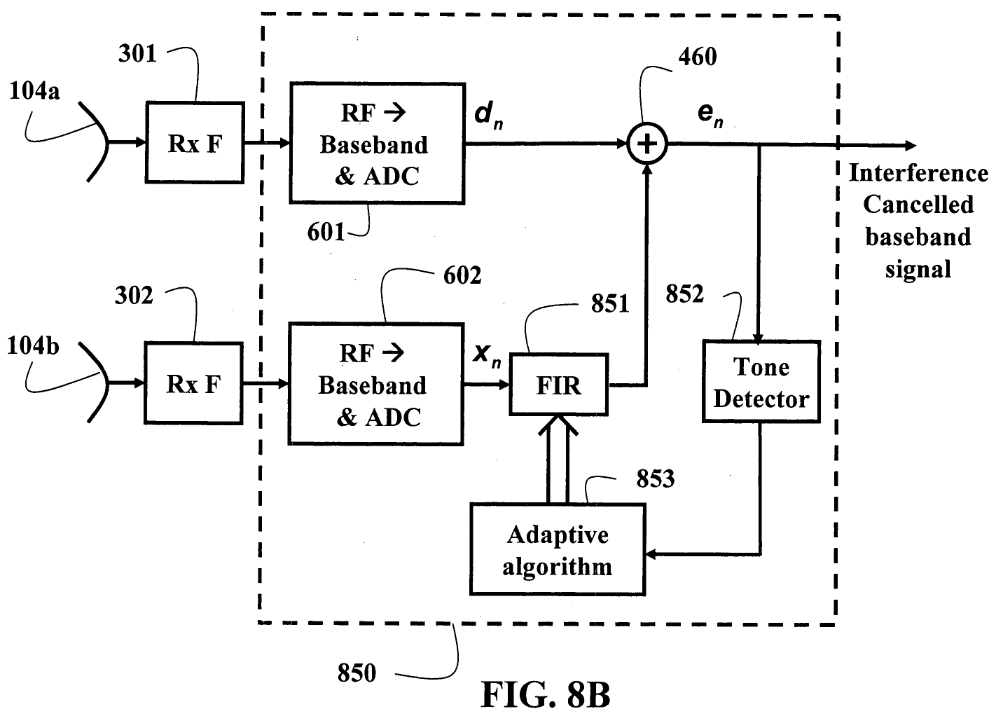

An apparatus with the pilot tone signal (analogous somewhat to the one described in FIG. 6A) is shown in FIG. 8A. The signal receiver is shown in 800. The invention specific components are pilot tone signal filters 801 and 802, the channel estimator 803 and the matrix generator and inverter 804. The channel estimator measures the relative phases and amplitudes of pilot tone signals in both propagation channels. Following this measurement, a matrix, representing the propagation channels is formed, by 804, and inverted, providing multiplying coefficients for multipliers 458 and 459.

Another implementation of the restorer 850 is shown in FIG. 8B. Similar to the restorer shown in FIG. 6B, feedback is used, by an adaptive algorithm 853, in order to adjust the coefficients of filter 851. A pilot tone signal detector 852 is used in the recovered signal during the time when the pilot tone signal is added to the interfering signal. Due to the adaptation and filtering, after a period of time, this recovered signal will not contain a significant amount of the pilot tone signal, and therefore, it may be expected that the signal restorer has successfully removed the transmitted signal which contained the pilot tone signal.

When the multipath time dispersion is large, the correction used in the restorer will usually require more than a single phase shift. Therefore implementations assisted by the sinusoidal pilot tone should be used primarily for propagation channels with low delay spread.

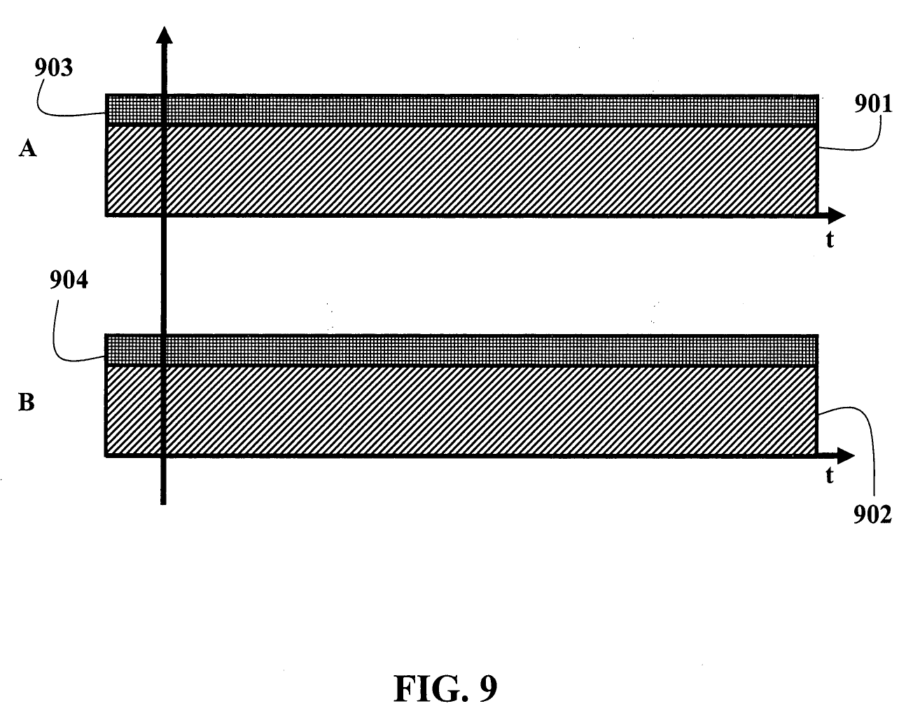

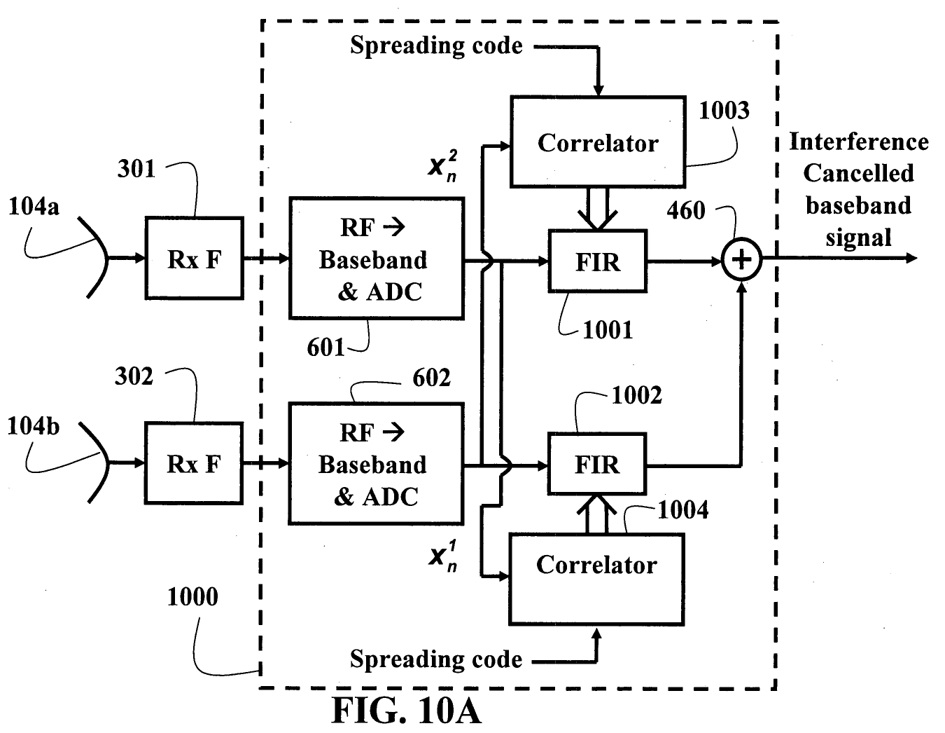

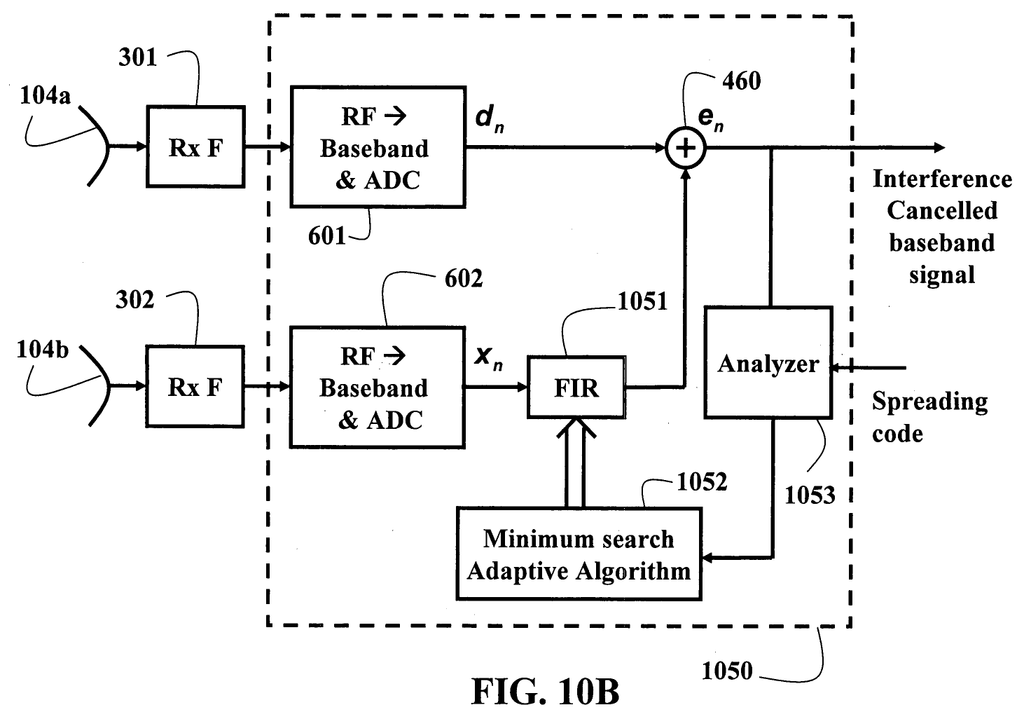

The signals shown in FIG. 9 show low level spread spectrum signals 903 and 904 which are added to each of the transmitted data bearing signals 901 and 902. The receiver utilizes these spread spectrum signals in order to estimate the propagation channels. These estimates are then used in the restorers shown in FIG. 10A and FIG. 10B. Both implementations have the advantage of maximizing data throughput since the signal transmission is not paused and that they are applicable to propagation channels with significant delay spread. It is worthwhile to note that, when the restorers are used to reconstruct spread spectrum signals, the codes for the original signals may be reused, so that the original signals may be superimposed in space, in frequency and in the code domain.

In FIG. 10A, the components specific to the restorer implementation in the receiver 1000, are the channel estimators based on the spread spectrum signals, shown as 1003 and 1004, the FIR filters 1001 and 1002 and the summing node 460. By supplying these channel estimators implemented as correlators, with the spreading code of the interfering signals and the factual received signals, the estimates of the propagation channels are calculated and supplied to FIR filters 1001 and 1002. After passing through FIR filters 1001 and 1002, the interfering signals in both arms of the signal summing node 460 are approximately identical and will cancel one another as it was described in the explanation accompanying FIG. 6C.

In FIG. 10B, an apparatus using feedback is presented. The output of the restorer 1050 is analyzed for the presence of the added spread spectrum signal associated with the interfering signal. This function is performed by the analyzer 1053 which is supplied with the spreading code of the interfering signal for the reference. The adaptive algorithm 1052 supplies an optimized set of coefficients to the FIR filter 1051 to minimize the magnitude of the signal detected, using an algorithm selected from those which are well known by those skilled in optimization theory.

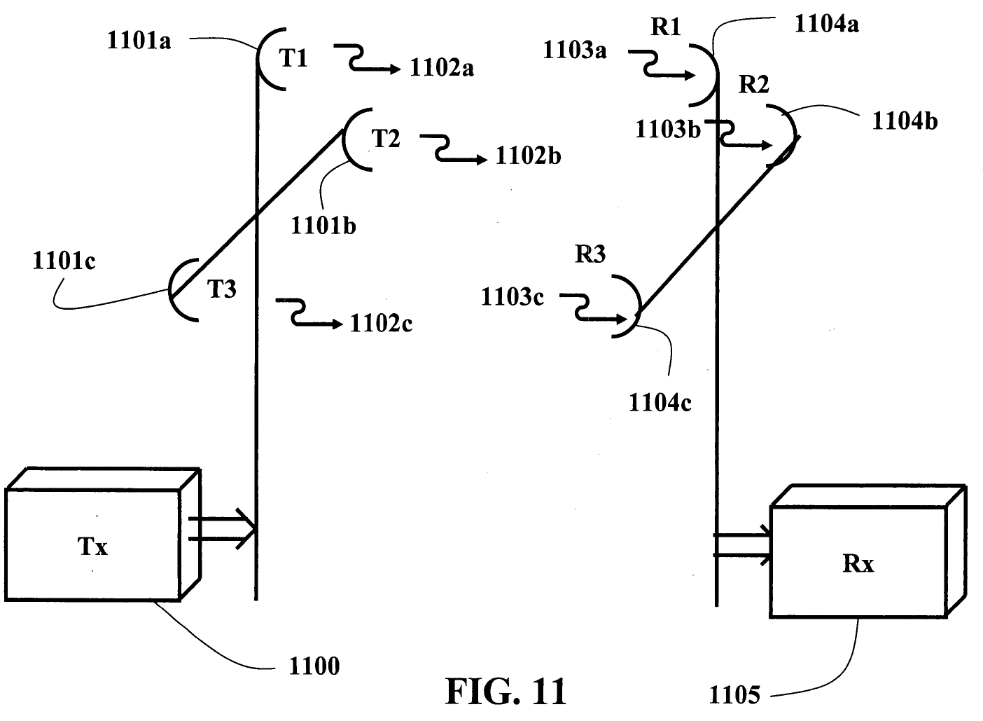

The implementations disclosed thus-far, may be extrapolated to situations where more than 2 antennas are used at each communication transmitter and receiver. FIG. 11 illustrates the case for 3 transmitting antennas 1101a, 1101b, and 1101c transmitting signals 1102a, 1102b, and 1102c. The 3 received signals are 1103a, 1103b, and 1103c, which are received by corresponding antennas 1104a, 1104b, and 1104c. Of course, systems with more than 3 antennas and, in fact, different spatial configurations of the multitude of antennas are quite possible. For the 3 antenna case, the data capacity of the communication system is effectively tripled. In the described embodiment, the 3 transmitting antennas are configured as an equilateral triangle. Also, the 3 receiving antennas are configured as a similar equilateral triangle. The transmitter 1100 will usually contain means to demultiplex the high speed input data stream into 3 lower speed data streams. Likewise, the receiver 1105 will usually contain means to multiplex the 3 lower speed received data streams into a single higher speed data stream. Similar to the 2 antenna case, the “direct paths” will be those associated with corresponding corners of the triangle of transmitting antennas and the triangle of receiving antennas. “Cross paths” are the other paths, and are slightly longer. In the implementation shown here, the separation between corners of the two triangles is selected so that the delay associated with each cross path causes a phase shift of approximately −120°, relative to the phase shift caused by the direct paths. The receiver techniques applicable for the two antenna case may be extended to the 3 antenna case.

By way of example, a third antenna may be added to the structure shown in FIG. 6A, and the matrix generation and inversion technique may be applied with the following modifications to the corresponding matrix, which now is of dimension 3×3. The matrix of estimated channel propagation coefficients would, in the ideal case, be

$${M}_{3} = [ \begin{matrix}1 & {ⅇ}^{- j \frac{2 π}{3}} & {ⅇ}^{- j \frac{2 π}{3}} \\ {ⅇ}^{- j \frac{2 π}{3}} & 1 & {ⅇ}^{- j \frac{2 π}{3}} \\ {ⅇ}^{- j \frac{2 π}{3}} & {ⅇ}^{- j \frac{2 π}{3}} & 1\end{matrix} ]$$

The phases applied at the receiver are taken from the inverse of this matrix which is given by

$${M}_{3}^{- 1} = \frac{1}{3} [ \begin{matrix}1 & {ⅇ}^{j \frac{2 π}{3}} & {ⅇ}^{j \frac{2 π}{3}} \\ {ⅇ}^{j \frac{2 π}{3}} & 1 & {ⅇ}^{j \frac{2 π}{3}} \\ {ⅇ}^{j \frac{2 π}{3}} & {ⅇ}^{j \frac{2 π}{3}} & 1\end{matrix} ]$$

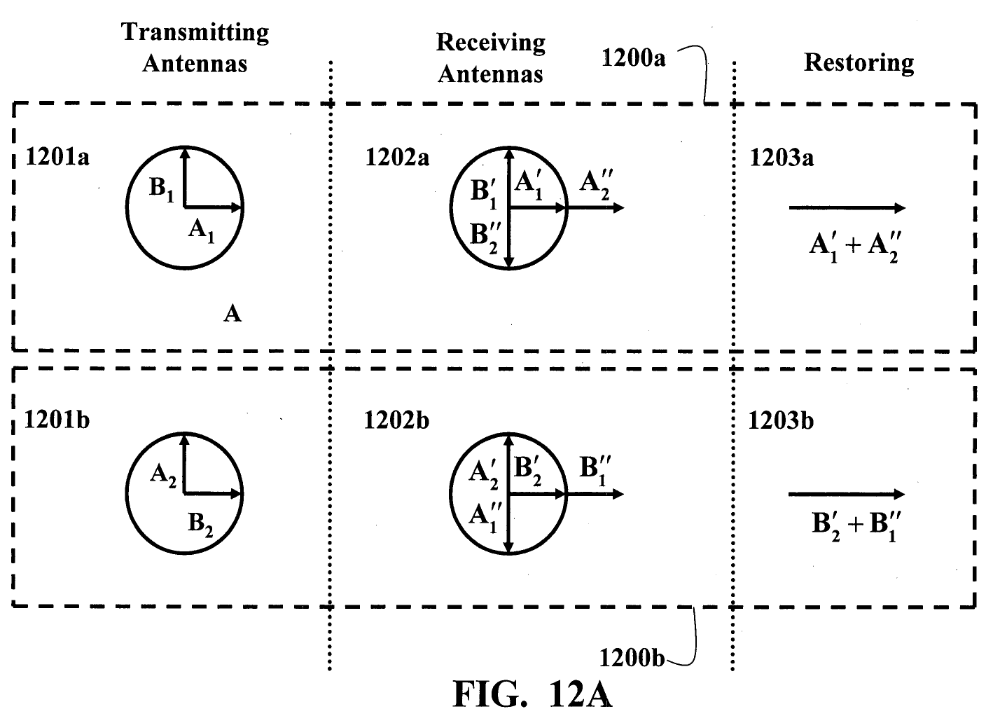

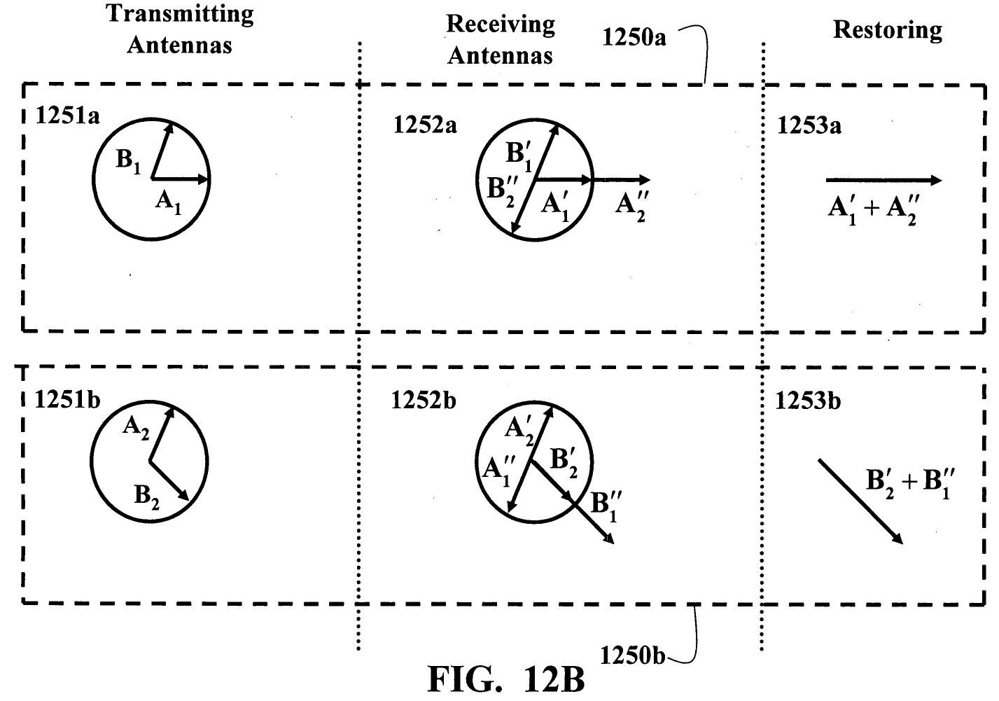

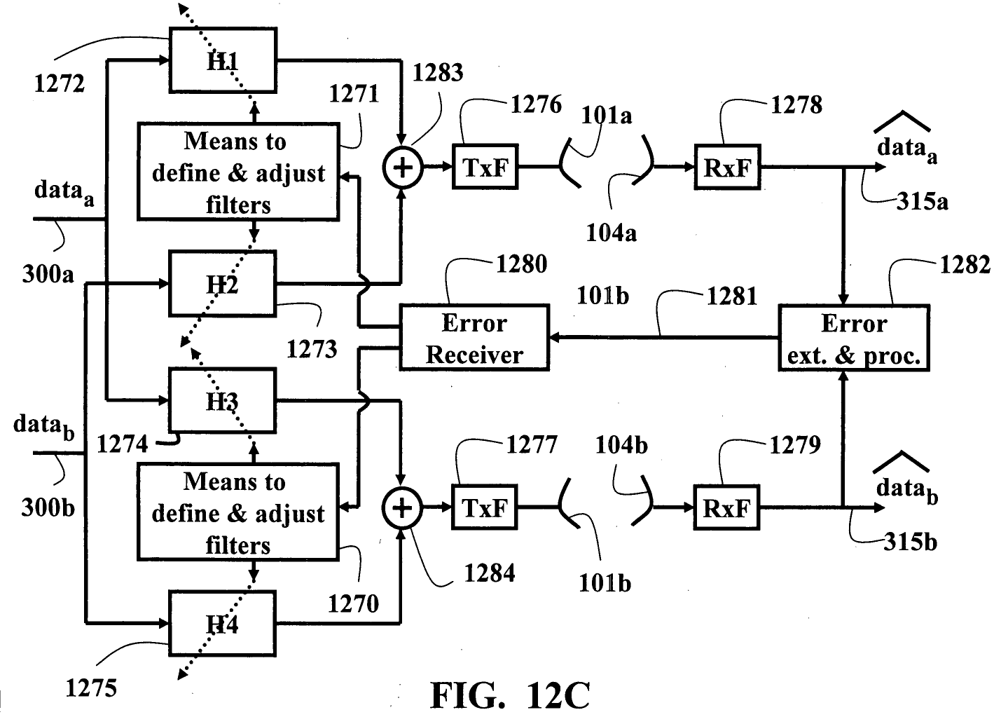

While the embodiments described so far rely on separation of superimposed signals with most of the processing performed at the receiving system of a communication system, it is fully conceivable to move some of the restoration function to the transmitting system. To describe this implementation, we will use a simple system with two transmitting and two receiving antennas, separated in the same optimized way as the system with 2 transmitter and 2 receiver antenna discussed previously ( i.e. in the ideal alignment case, the cross paths are a quarter of a wavelength longer than the direct paths). The phasors of the signals, for this case, are shown in FIG. 12A. The signals will again be referred to as “A” and “B”. The subscript, either 1 or 2, will indicate which transmitting antenna the signal originated from, and single primes (“A′” or “B′”) will indicate signals which have propagated through a direct path and double primes (“A″” or “B″”) will indicate a signal which has propagated through a cross path. The signal “A” will be considered to be the desired signal for the first restorer and the interfering signal for the second restorer. The signal “A” is shown to be transmitted with no phase change from 101a and a phase advance of 90° from 101b. The signals corresponding to the first restorer are shown in 1200a and the second restorer in 1200b. 1201a shows the two phasors which make up the first transmitted signal, and 1201b show the two phasors which make up the second transmitted signal. The phasors of the received signals are shown in 1202a and 1202b. The signals superimpose at the receiver antennas, giving the restored signals shown as phasors in 1203a and 1203b. The result of the design of this system is that the interfering signals would destructively interfere and the desired signals would constructively combine.

When the antenna alignment is changed, the phases between additionally injected signals “B₁” and “A₂” needs to be adjusted, but so long as the advancement of additionally injected signals adds up to 180° (sum of angle between signal phasors A1 and B1 and angle between signal phasors B2 and A2), the cancellation of interfering signals and optimum combining of the desired signal may be achieved. An illustration of the phasor orientation, for this case, at the transmitting and receiving ends of the system is shown in FIG. 12B. The signals corresponding to the first restorer are shown in 1250a and the second restorer in 1250b. 1251a shows the two phasors which make up the first transmitted signal and 1251b show the two phasors which make up the second transmitted signal. The phasors of the received signals are shown in 1252a and 1252b.

The signals superimpose at the receiver antennas, giving the phasors shown in 1253a and 1253b.

Premixing of the signals at the transmitting system is quite suitable for stationary systems, when the advancement of the injected signals can be calculated and remains relatively constant. In general circumstances, e.g. non-negligible antenna motion, this method will require a feedback link from the receiver, back to the transmitter, in order to update the correct phase adjustments on the injected signals. This method does not have to be limited to the systems described above and may be extended to systems utilizing more than two receiving and transmitting antennas.

FIG. 12C shows a block diagram of a communication system which premixes the signals at the transmitting end, and uses a feedback link from receiver to transmitter. The transmitting system, in addition to elements known to those skilled in the art include, but are not limited to modulators, upconverters, power amplifiers and other components shown collectively as T×F 1276 and 1277, may contain filters H1 1272, H2 1273, H3 1274, and H4 1275 as well as means 1270 and 1271 to control the filters attributes and summing nodes 1283 and 1284. Also, a feedback means 1281 may be provided to provide an “error” signal transmitted by the receiver subsystem 1282 and received by 1280. This error signal is used to calculate the adjustments in the filters 1272, 1273, 1274 and 1275. These filters may be simple phase shifters, or more complicated adaptive filters as mentioned in the descriptions for FIGS. 6a and 6b. The goal of these adaptive algorithms may be to reduce the error signals which are transmitted on the feedback link 1281. The receiver will contain, in addition to components well known to those skilled in the art, include but are not limited to downconverters, LNAs, and mixers shown collectively in 1278 and 1279, an error extraction and processing means 1282.

The error signal may be calculated with the aid of pauses in the transmitted signals, the injection of pilot tone signals or the injection of low level spread spectrum signals.

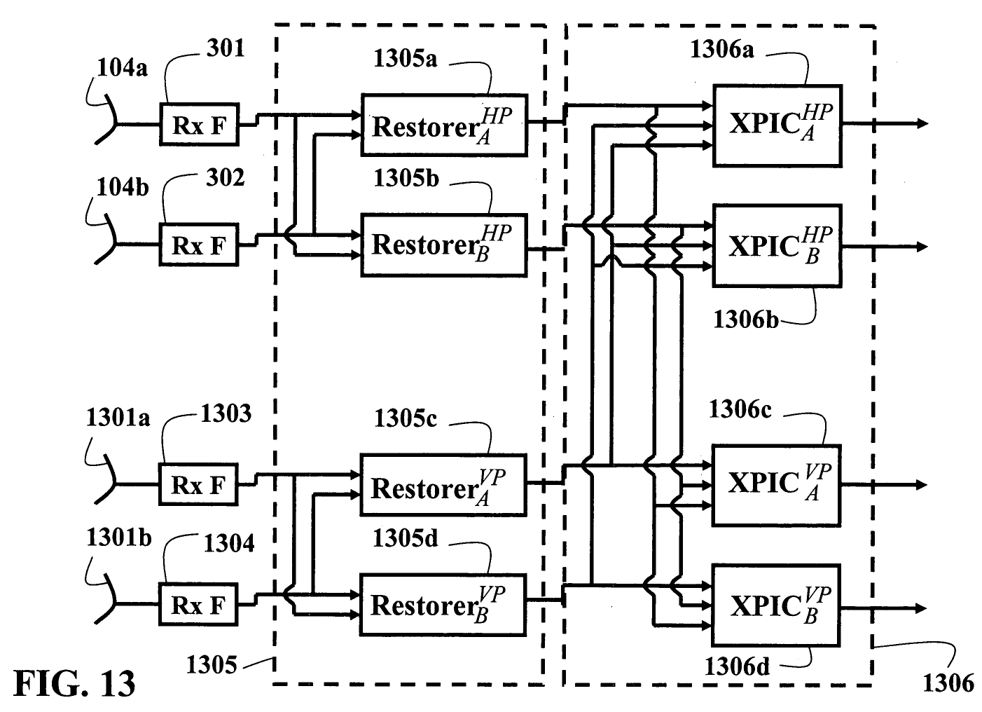

FIG. 13 shows the restorers, described in this patent in combination with cross polarization and optional cross polarization interference cancellers (XPICs). One may approximately double the data carrying capacity of a telecommunication's link by exploiting the orthogonal polarizations of the signal, independently of the increase in throughput obtained with the restorers. The horizontal and vertical polarizations are indicated here by the superscripts ^{“HP”} and ^{“VP”}, respectively. The components which would be present without cross polarization signals are shown as input to the receiver antennas 104a and 104b, and the restorers 1305a and 1305b which are shown as 2 of the 4 restorers 1305. The additional components in a system which utilizes cross polarization are the vertically aligned antennas 1301a and 1301b, the R× front ends, 1303 and 1304, additional restorers shown as 1305c and 1305d, and optionally, the XPICs shown collectively as 1306, comprised of individual XPICs 1306a, 1306b, 1306c, and 1306d. In this figure, restorer 1305a restores the horizontally polarized component of the first transmitted signal and restorer 1305b restores the horizontally polarized component of the second transmitted signal. Similarly, restorer 1305c restores the vertically polarized component of the first transmitted signal and restorer 1305d restores the vertically polarized component of the second transmitted signal. As with any system using cross polarization, there is often cross talk between the polarizations. For example, an XPIC may be designed to operate on the horizontally polarized signal by removing interference arising from the vertically polarized signal. In such a case, when the cross polarization system is combined with the techniques presented in this disclosure, the performance of an XPIC would be improved by including an input for the cross polarized interfering signal, i.e. each XPIC would have 3 inputs. The restorers may make use of any of the (suitably modified) techniques described previously. While this particular embodiment illustrates a combination of the restorer with polarization diversity means, one skilled in the art of communication may easily realize that any other diversity means may be used instead of polarization diversity including but not limited to frequency diversity, code diversity for spread spectrum signals, space diversity and time diversity.

Although the disclosure describes and illustrates preferred embodiments of the invention, it is to be understood that the invention is not limited to these particular embodiments.

Many variations and modifications will now occur to those skilled in the art of radio communications. For a definition of the invention, reference is to be had to the attached claims.

We claim:

1. A communication system for simultaneous transmission, reception and restoration of a plurality of individual signals superimposed in space and frequency, comprising
a plurality of collocated transmitter antennas transmitting signals which reuse a common frequency band,
a plurality of collocated receiver antennas receiving signals which reuse a common frequency band,
a set of filters, having at least one filter, which is used to process the said received or transmitted signals, and
at least one summing node which sums the signals produced by the said filters restoring at least one original individual signal and reducing the interference resulting from simultaneous transmission of a plurality of signals.

2. The communication system recited in claim 1 where the separation between the transmitting antennas as well as the separation between the receiving antennas are optimized relative to the distance between the transmitter site and the receiver site so that when, during the restoration of individual signals, the interfering signal is removed, the desired signal is extracted with a constructive superposition.

3. The communication system recited in claim 1 where each individual signal is assigned to a single transmitting antenna and the signal restoration is performed in the receiving system.

4. The communication system recited in claim 3 wherein the signal restoration is performed, on the received signals at the carrier (or an intermediate) frequency.

5. The communication system recited in claim 3 wherein the received signals are first translated to baseband and the restoration of the signals is performed at baseband.

6. The communication system recited in claim 3 which contains means which define the attributes of the said set of filters using training signals.

7. The communication system recited in claim 3 which contains means which define the attributes of the said set of filters during the pausing of the transmission of one or more of the transmitted signals.

8. The communication system recited in claim 5 where the said set of filter's responses are estimates of the responses of the propagation channels between various combinations of transmitter/receiver antenna.

9. The communication system recited in claim 5 where at least one filter in the set of filters is each reduced to a single tap adjusting the phase and amplitude of the received signal.

10. The communication system recited in claim 4 where at least one filter is reduced to a phase shifter and amplitude adjustment.

11. The communication system recited in claim 3 which contains means which define the attributes of the said set of filters, using a pilot tone signal which is injected alternately into each transmitted signal in a way that does not interfere with the transmitted data signals.

12. The communication system recited in claim 5 which contains means which define the attributes of the said set of filters using spread spectrum signals which are overlaid on each of the said set of data signals.

13. The communication system recited in claim 1 where the signals entering the transmitting system are filtered and premixed in the said system so that the restoration process may be accomplished directly by the physical summing of radio waves on the individual receiving antennas.

14. The communication system recited in claim 13 where a feedback signal from the receiving system to the transmitting system is used to control the signal premixing.

15. A communication system recited in claim 1 comprising some signal premixing at the transmitter site and some signal restoration at the receiving site.

16. A communication system recited in claim 1 including diversity means known from the prior art, wherein the diversity means provide for the system's information throughput increase approximately proportional to the diversity order, and the simultaneous transmission of individual signals superimposed in space and frequency provides for an additional information throughput increase approximately proportional to the number of superimposed signals.

17. A communication system recited in claim 16 processing two orthogonally polarized electromagnetic signals.

18. A method for simultaneous transmission, reception and restoration of a plurality of individual signals superimposed in space and frequency, comprising
transmitting and receiving a plurality of signals where the transmitting antennas are collocated and the receiving antennas are collocated and the said antennas reuse a common frequency band,
applying a set of filters, containing at least one filter, to the said received or transmitted signals, and
summing the signals processed by the said filters restoring at least one original signal and reducing the interference resulting from the simultaneous transmission of a plurality of signals.

19. A method recited in claim 18 where the separation between the transmitting antennas as well as the separation between the receiving antennas is optimized relative to the distance between transmitting antennas and receiving systems so that when the interfering signal is removed the desired signal is extracted with a constructive superposition.

20. The method recited in claim 18 where each individual signal is assigned to a single transmitting antenna and the signal restoration is performed in the receiver.

21. The method recited in claim 20 where the said set of filter attributes are defined using training signals.

22. The method recited in claim 20 wherein the said set of filter attributes are defined during the pausing of the transmission of one or more of the transmitted signals.

23. The method recited in claim 20 where the said set of filter's response's are estimates of the responses' of the propagation channels between various combinations of transmitter/receiver antenna.

24. The method recited in claim 20 where the channel propagation matrix is defined and subsequently inverted.

25. The method recited in claim 20 where the said set of filter attributes are determined by adaptive techniques.

26. The method recited in claim 20 where an additional signal is injected in a way that does not interfere substantially with the transmitted data signals, and the said additional signal is subsequently cancelled, thereby canceling the interferers.

27. The method recited in claim 20 where an additional signal is injected in a way that does not interfere substantially with the transmitted data signals, and the said additional signal is used to estimate the said set of filter's attributes.

28. The method recited in claim 18 where the original signal filtering and premixing is done in the transmitter so that the restoration process may be accomplished directly by the physical summing of radio waves on the individual receiving antennas.

29. A restorer apparatus for use in a system utilizing simultaneous transmission of multiple radio signals superimposed in space and frequency, comprising
interface means to a plurality of collocated receiver antennas processing signals which reuse a common frequency band,
a set of filters, consisting of at least one filter, which is used to filter the said received signals, and
at least one summing node which sums the signals produced by said filters restoring at least one original individual signal and reducing the interference resulting from simultaneous transmission of a plurality of signals.

30. The restorer apparatus of claim 29 using training patterns and pauses in the transmitted signals and where the said set of filters attributes are calculated by estimation and inversion of a propagation channel matrix.

31. The restorer apparatus of claim 29 using pauses in at least one of the transmitted signals, canceling the interference at the output of at least one summing node during pauses, using an adaptive algorithm which adapts attributes of the said set of filters.

32. The restorer apparatus of claim 29 using training patterns and pauses in the transmitted signals to estimate propagation channel responses, and applying these to the said set of filters.

33. The restorer apparatus of claim 29 using pilot tone signals where the said set of filters attributes' are calculated by estimating a propagation channel matrix based on the phases and amplitudes of the received pilot tones, and inverting the said matrix.

34. The restorer apparatus of claim 29 using at least one pilot tone signal, canceling the pilot tone at the output of at least one summing node, using an adaptive algorithm which adapts attributes of the said set of filters.

35. The restorer apparatus of claim 29 using additional spread spectrum signals in the transmitted signals, to estimate propagation channel responses, and applying these to the said set of filters.

36. The restorer apparatus of claim 29 using at least one spread spectrum signal, canceling the spread spectrum signal at the output of at least one summing node, using an adaptive algorithm which adapts attributes of the said set of filters.
